(19) United States
(12) Patent Application Publication
(10) Pub. No.: US 2017/0359565 A1
(43) Pub. Date: Dec. 14, 2017

(54) IMAGE PICKUP DEVICE AND IMAGE PICKUP METHOD

(71) Applicant: SONY CORPORATION, Tokyo (JP)

(72) Inventor: Katsuhisa ITO, Tokyo (JP)

(73) Assignee: SONY CORPORATION, Tokyo (JP)

(21) Appl. No.: 15/535,560

(22) PCT Filed: Feb. 8, 2016
(86) PCT No.: PCT/JP2016/053716

§ 371 Date: Jun. 13, 2017

(30) Foreign Application Priority Data
Feb. 20, 2015 (JP) 2015-032006

(51) Int. Cl. H04N 13/02; G06T 7/50; H04N 13/00; H04N 5/225

(52) U.S. Cl. CPC H04N 13/0203; H04N 5/225; H04N 13/0282; G06T 7/50; H04N 13/0014; G06T 2207/10028

(57) ABSTRACT

There is provided an image pickup device and an image pickup method for estimating the depth of an image having a repetitive pattern with high accuracy. The peripheral cameras are arranged according to base line lengths based on reciprocals of different prime numbers as having a position of a reference camera, to be a reference when images from different viewpoints are imaged, as a reference. The present disclosure is capable of being applied to a light field camera and the like, for example, which includes the reference camera and the plurality of peripheral cameras, generates a parallax image from the images of plural viewpoints, and generates a refocus image by using the images from the plural viewpoints and the parallax image.

### TECHNICAL FIELD

The present disclosure relates to an image pickup device and an image pickup method, and especially to an image pickup device and an image pickup method which can estimate the depth of an image having a repetitive pattern with high accuracy.

### BACKGROUND ART

An image pickup device such as a light field camera end a camera for estimating a depth according to a multi-baseline stereo method (referred to as multi-baseline stereo camera) includes plural cameras for imaging images from different viewpoints. Then, the image pickup device estimates the depth of an object in a captured image by performing block matching to a captured image of a predetermined camera and a captured image of the other camera.

As an image pickup device having a plurality of cameras, an image pickup device having a plurality of cameras arranged at non-equal intervals (for example, refer to Patent Document 1).

### CITATION LIST

### Patent Document

Patent Document Japanese Patent Application Laid-Open No. 11-125522

### SUMMARY OF THE INVENTION

### Problems to be Solved by the Invention

Meanwhile, in the world created by human beings such as the inside of a room and an urban scenery, an enormous number of simple repetitive patterns are included. Therefore, if such a world is used as an object of the image pickup device such as a light field camera and a multi-baseline stereo camera and block matching is performed, blocks having high correlation are repeatedly appear, and it is difficult to accurately estimate the depth.

The present disclosure has been made in consideration of the above state and can estimate the depth of the image having the repetitive pattern with high accuracy.

### Solutions to Problems

An image pickup device according to a first aspect of the present disclosure is an image pickup device including a plurality of imaging units which is arranged according to a base line length based on a reciprocal of a different prime number having a position of an imaging unit, to be a reference when images from different viewpoints are imaged, as a reference.

In the first aspect of the present disclosure, the plurality of imaging units is included which is arranged according to the base line length based on the reciprocal of the different prime number having the position of the imaging unit, to be a reference when the images from the different viewpoints are imaged, as a reference.

An image pickup method according to a second aspect of the present disclosure is an image pickup method including a step of imaging images from different viewpoints by a plurality of imaging units and an imaging unit to be a reference arranged according to base line lengths based on reciprocals of different prime numbers as having a position of the imaging unit, to be the reference when images from different viewpoints are imaged, as a reference.

In the second aspect of the present disclosure, the plurality of imaging units and the imaging unit to be a reference, which are arranged according to the base line lengths based on the reciprocals of the different prime numbers as having the position of the imaging unit, to be a reference when the images from different viewpoints are imaged, as a reference, image images from different viewpoints.

The reciprocal of the prime number is not strictly a value of the reciprocal of the prime number and means a value within a range, in which an effect of the present disclosure can be obtained, including the value.

### Effects of the Invention

According to the first and second aspects of present disclosure, an image can be imaged. Also, according to the first and second aspects of the present disclosure, the depth of the image having a repetitive pattern can be estimated with high accuracy,

Note that the effects described herein are not limited and that the effect may be any effects described in the present disclosure.

### BRIEF DESCRIPTION OF DRAWINGS

FIG. 1 is a perspective diagram of an exemplary arrangement of cameras included in a stereo camera.

FIG. 2 is a diagram of exemplary captured images captured by the stereo camera in FIG. 1.

FIG. 3 is a perspective diagram of an exemplary arrangement of cameras included in a light field camera.

FIG. 4 is a diagram of exemplary captured images captured by a reference camera and peripheral cameras in FIG. 3.

FIGS. 5A to 5C are diagrams of exemplary correlation values in a case where a base line length X₁ is twice a base line length X₂.

FIGS. 6A to 60 are diagrams of exemplary correlation values in a case where the base line length X₁ is three halves of the base line length X₂.

FIG. 7 is a block diagram of an exemplary configuration of one embodiment of a light field camera as an image pickup device to which the present disclosure has been applied.

FIG. 8 is a block diagram of an exemplary configuration of an imaging unit in FIG. 7.

FIG. 9 is a perspective diagram of a first arrangement example of a reference camera and peripheral cameras of the imaging unit in FIG. 7.

FIG. 10 is a perspective diagram of a second arrangement example of the reference camera and the peripheral cameras of the imaging unit in FIG. 7.

FIG. 11 is a perspective diagram of a third arrangement example of the reference camera and the peripheral cameras of the imaging unit in FIG. 7

FIG. 12 is a perspective diagram of a fourth arrangement example of the reference camera and the peripheral cameras of the imaging unit in FIG. 7.

FIG. 13 is a perspective diagram of a fifth arrangement example of the reference camera and the peripheral cameras of the imaging unit in FIG. 7.

FIG. 14 is a chart to describe the first to fifth arrangement examples of the reference camera and the peripheral cameras respectively illustrated in FIGS. 9 to 13 and effects obtained by the above arrangements.

FIG. 15 is a flowchart to describe imaging processing.

FIG. 16 is a block diagram of an exemplary configuration of hardware of a computer.

FIG. 17 is a block diagram of an exemplary schematic configuration of a vehicle control system.

FIG. 18 is an explanatory diagram of exemplary set positions of an external information detecting section. and an imaging unit.

### MODE FOR CARRYING OUT THE INVENTION

The premise of the present disclosure and embodiments for carrying out the present disclosure (referred to as embodiments below) are described below. Note that, the description will be in the following order.

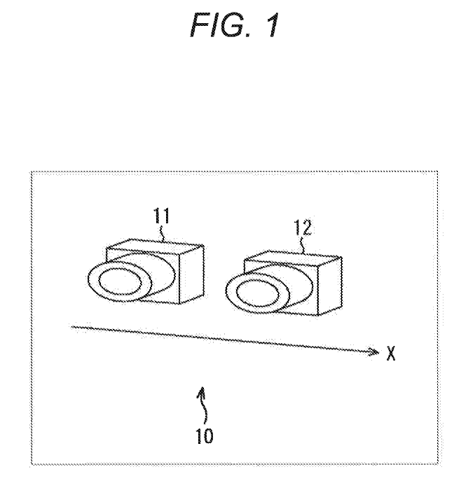

0. Premise of the present disclosure (FIGS. 1 to 4)

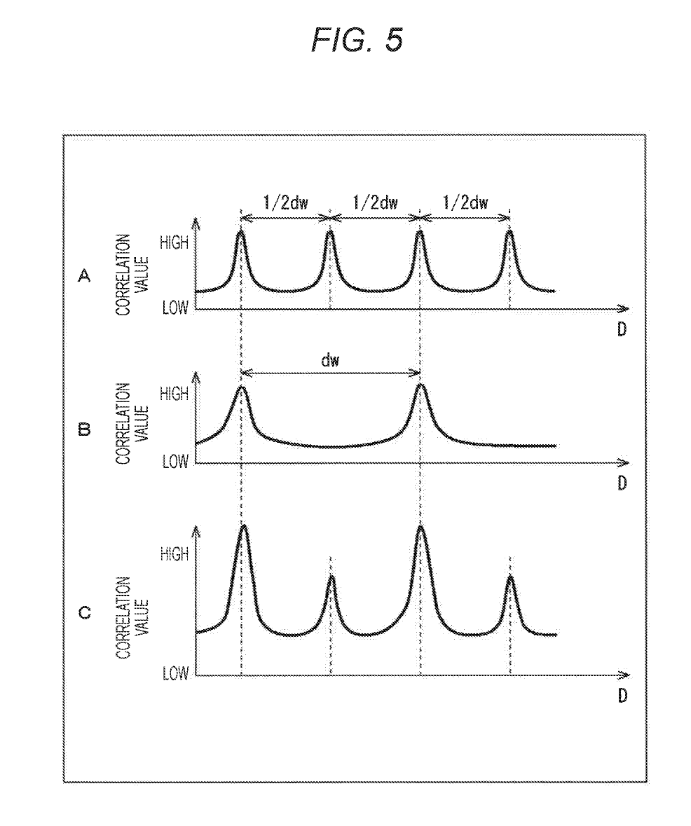

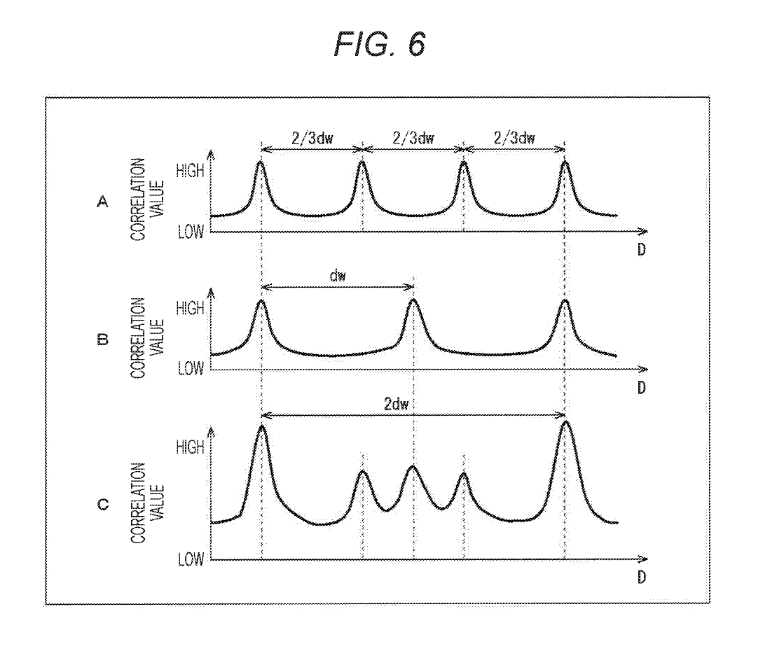

1. Outline of the present technology (FIGS. 5A to 5C and 6A to 6C)

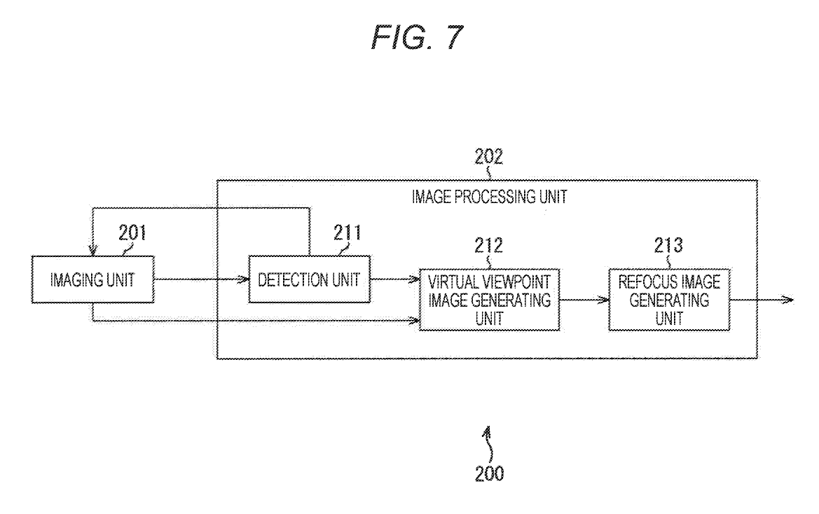

2. First embodiment: light field camera (FIGS. 7 to 15)

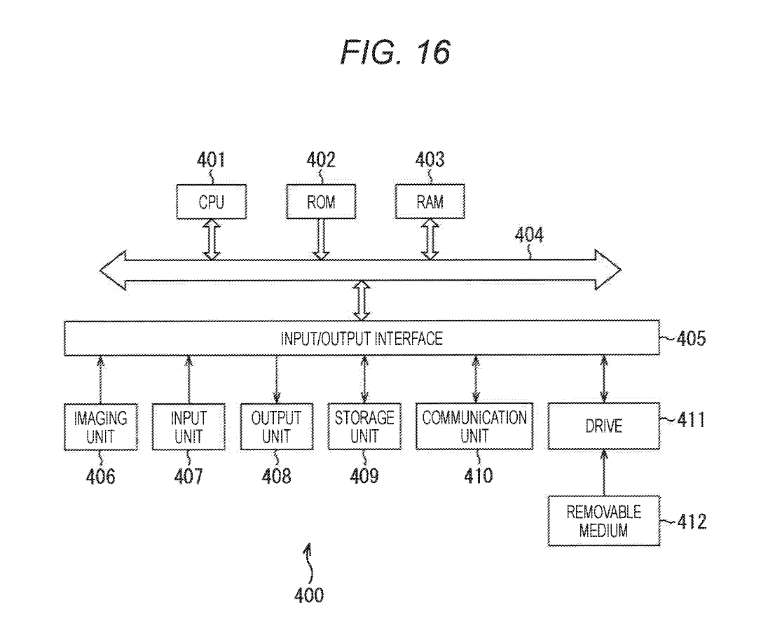

3. Second embodiment: computer (FIG. 16)

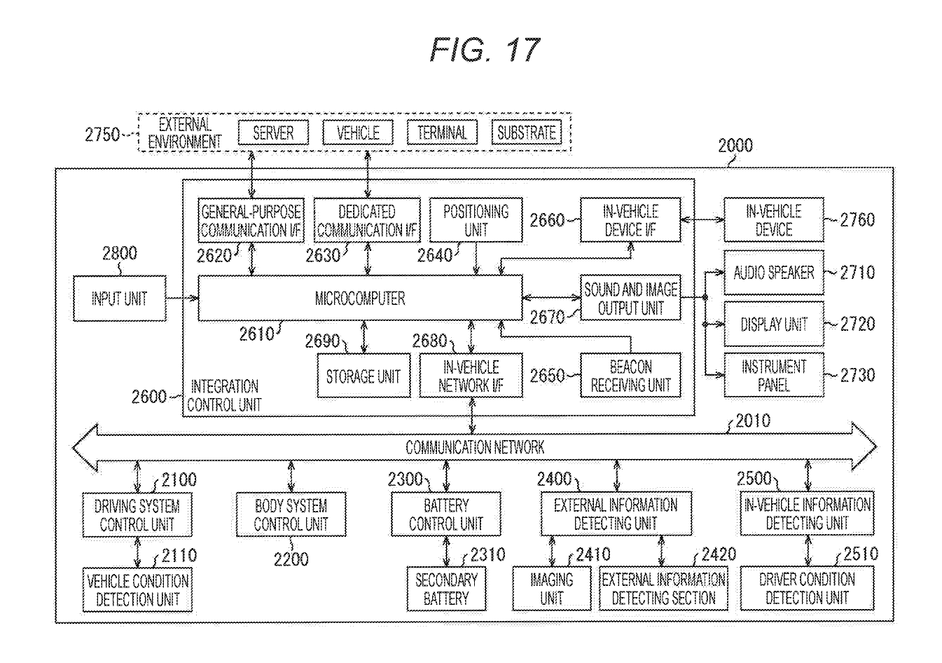

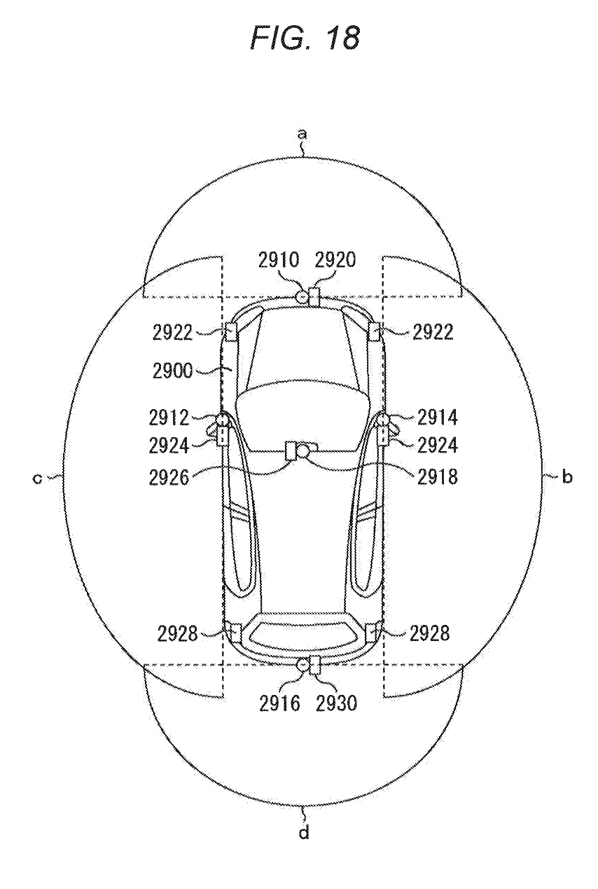

4. Modification (FIGS. 17 and 18)

<Premise of the Present Disclosure>

(Exemplary Arrangement of Cameras Included in Stereo Camera)

FIG. 1 is a perspective diagram of an exemplary arrangement of cameras included in a stereo camera.

A stereo camera 10 in FIG. 1 includes two cameras 11 and 12, and the cameras 11 and 12 are aligned in the horizontal direction (X direction).

(Exemplary Captured Image Captured by Stereo Camera)

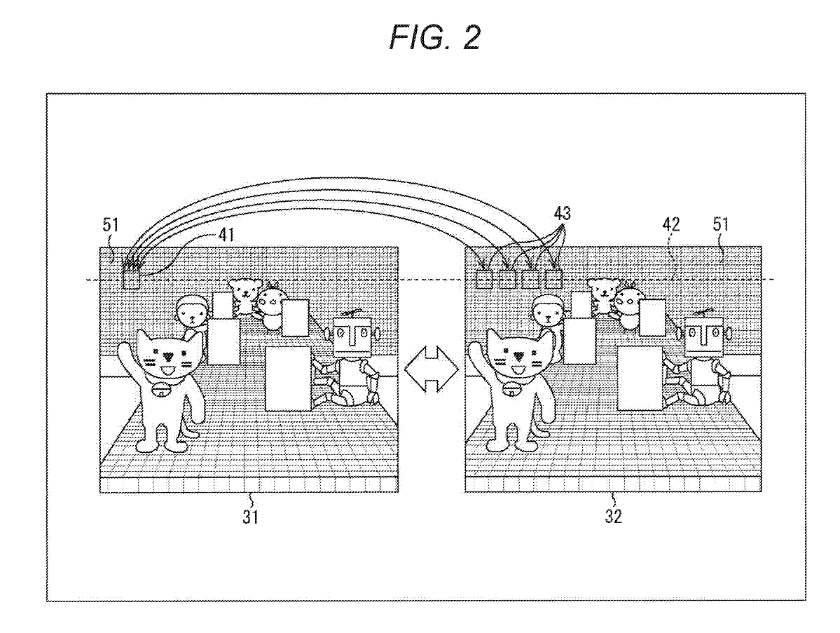

FIG. 2 is a diagram of exemplary captured images captured by the stereo camera 10 in FIG. 1.

In the example in FIG. 2, a captured image 31 is captured by the camera 11 of the stereo camera 10, and a captured image 32 is captured by the camera 12.

In this case, block matching is sequentially performed between a block 41 in the captured image 31 and a plurality of blocks 43 in the captured image 32 existing on an epipolar line 42 of the block 41. Also, a depth of an object in the captured image 31 is estimated on the basis of a difference between the positions of the blocks 41 and 43 having the highest correlation in the horizontal direction.

However, as illustrated in FIG. 2, in a case where the captured images 31 and 32 have checkered pattern 51 including repetitive patterns in the horizontal direction and the vertical direction and spaces in the checkered pattern 51 are small, the blocks 43 having the high correlation with the block 41 appear at predetermined intervals. Therefore, there is a high possibility that an incorrect block 43 is selected as a block having the highest correlation with the block 41, and it is difficult to accurately estimate the depth.

(Exemplary Arrangement of Cameras Included in Light Field Camera)

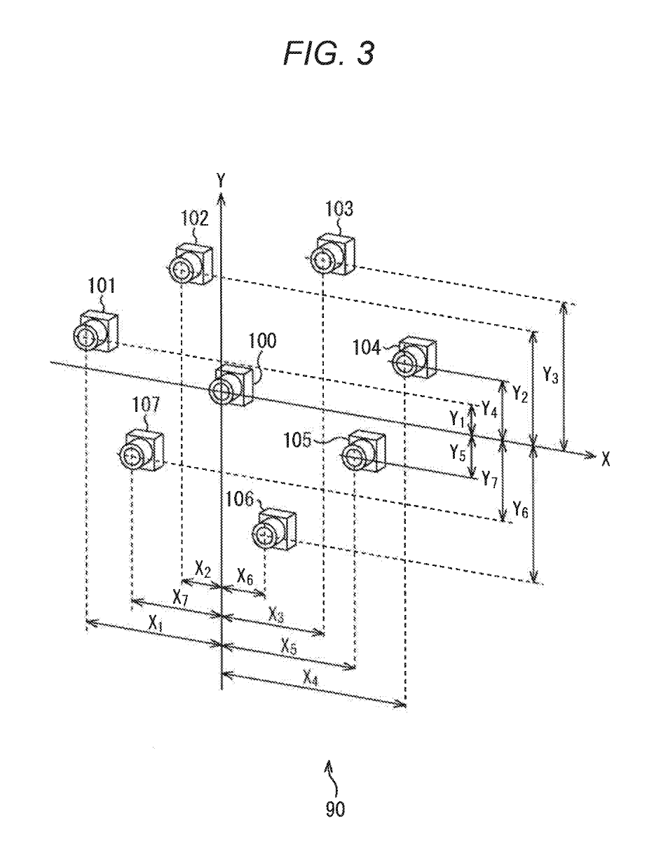

FIG. 3 is a perspective diagram of an exemplary arrangement of cameras included in a light field camera.

A light field camera 90 in FIG. 3 includes a single reference camera 100 and seven peripheral cameras 101 to 107. The reference camera 100 and the peripheral cameras 101 to 107 are arranged on a XY plane with the position of the reference camera 100 defined as the origin (0, 0). Coordinates of the positions of the peripheral cameras 101 to 107 are (X₁, Y₁), (X₂, Y₂), (X₃, Y₃), (X₄, Y₄), (X₅, Y₅), (X₆, Y₆), and (X₇, Y₇).

(Exemplary Captured Image Captured by Light Field Camera)

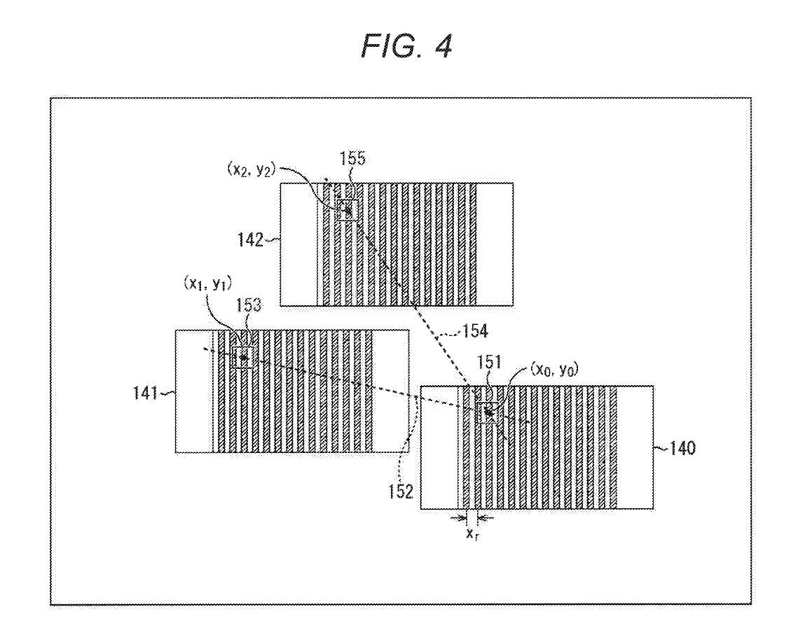

FIG. 4 is a diagram of exemplary captured images captured by the reference camera 100 and the peripheral cameras 101 and 102 in FIG. 3.

In the example in FIG. 4, in a captured image 140 captured by the reference camera 100, a vertically-striped repetitive pattern having xᵣ-pixel intervals exists. In this case, the peripheral camera 101 captures the captured image 141, and the peripheral camera 102 captures the captured image 142.

When the depth of the position (x₀, y₀) in the repetitive pattern in the captured image 140 is estimated, the center position (x₁, y₁) of the block 153 in the captured image 141 on an epipolar line 152 of the block 151 to be matched with the block 151 having the position x₀, y₀) as a center is calculated by the following formula (1).

[Mathematical Formula 1]

x₁=x₀+X₁×D/a

y₁=y₀+Y₁×D/a (1)

Note that the D is a disparity value indicating parallaxes corresponding to the blocks 151 and 153 and a value indicating the position of the object in the depth direction which exists in both the blocks 151 and 153. Integers of zero or more are sequentially substituted in the disparity value D. With the above substitution, the blocks in the captured image 141 on the epipolar line 152 of the block 151 are sequentially assumed as the block 153. Also, the a is an optional coefficient to determine a moving amount of the block 153.

Similarly, when the depth of the position (x₀, y₀) in the captured image 140 is estimated, the center position (x₁, y₂) of the block 155 in the captured image 142 on an epipolar line 154 of the block 151 to be matched with the block 151 is calculated by the following formula (2).

[Mathematical Formula 2]

x₂=x₀+X₂×D/a

y₂=y₀+Y₂×D/a (2)

Also, the center position of the block in each of the captured images of the peripheral cameras 103 to 107 to be matched with the block 151 is calculated similarly to the center position (x₁, y₁). Therefore, the center positions (xₙ, yₙ) (n=1, 2, . . . , and 7) of the blocks in the captured images captured by the respective peripheral cameras 101 to 107 to be matched with the block 151 are represented by the following formula (3).

[Mathematical Formula 3]

xₙ=x₀+Xₙ×D/a

yₙ=y₀+Yₙ×D/a (3)

Then, in a case where the sum of sum of absolute difference (sum of SAD (SSAD)), the sum of sum of squared difference (sum of SSD (SSSD)), and the like are employed as a method for estimating the depth, block matching is sequentially performed to the blocks 151 and 153, and a correlation value is obtained for each block 153. Then, the correlation value of each block 153 is held in association with the disparity value D corresponding to the block 153.

Also, similarly, regarding the block 155, block matching is sequentially performed to the blocks 151 and 155, and a correlation value is held in association with the disparity value D. This block matching is also performed to the captured images captured by the reference camera 100 and the peripheral cameras 103 to 107. Then, all the held correlation values of the captured images of the peripheral cameras 101 to 107 are added for each disparity value D, and a disparity value D having the largest total value is used as the depth estimation result. Here, note that the higher the correlation is, the larger the correlation value is.

Here, when it is assumed that a range of D be equal to or more than zero and equal to or less than the moving amounts of xₙ and yₙ, that is, the widths xwₙ and ywₙ of a block matching searching range are expressed by the following formula (4).

[Mathematical Formula 4]

xwₙ=Xₙ×Dₘₐₓ/a

ywₙ=Xₙ×Dₘₐₓ/a

Therefore, when the intervals in the x direction and the y direction in the repetitive pattern included in the captured image 140 are respectively larger than the widths xwₙ and ywₙ, the number of the repetitive patterns included in the block matching searching range is equal to or less than one. Therefore, incorrect recognition of the depth estimation caused by the repetitive pattern does not occur.

According to the above description, to prevent the incorrect recognition of the depth estimation caused by the repetitive pattern, it is necessary to reduce Xₙ and Yₙ (n=1, 2, . . . and 7) which are the base line lengths of the reference camera 100 and the peripheral cameras 101 to 107 in the x direction and the y direction so as to reduce the widths xwₙ and ywₙ as possible. However, when the base line length Xₙ and the base line length Yₙ are reduced, the accuracy of triangulation of the disparity value is deteriorated. Therefore, it is difficult to estimate the depth of the image having the repetitive pattern with high accuracy.

<Outline of the Present Technology>

(Relation Between Base Line Length of Peripheral Camera, and Correlation Value)

FIGS. 5A to 5C are diagrams of exemplary correlation values of the block 151 and the block 153, and the blocks 151 and 155 in a case where the base line length is twice the base line length X₂, that is, in a case where the reference camera 100 and the peripheral cameras 101 and 102 are arranged at equal intervals in the horizontal direction.

Note that, in FIGS. 5A to 5C, the horizontal axis indicates a disparity value D corresponding to the blocks 151 and 153 or the blocks 151 and 155, and the vertical axis indicates a correlation value corresponding to the disparity value D. This is similarly applied to FIGS. 6A to 6C to be described later.

Also, FIG. 5A is a graph illustrating the correlation value of the blocks 151 and 153, and FIG. 5B is a graph illustrating the correlation value of the blocks 151 and 155. FIG. 5C is a graph illustrating a total correlation values (SSAD) obtained by adding the correlation value of the blocks 151 and 153 to the correlation value of the blocks 151 and 155.

In a case where the base line length X₁ is twice the base line length X₂, the x coordinate x₁ of the block 153 moves by 2ₓ, if the x coordinate x₂ of the block 155 moves by xᵣ according to the above-described formulas (1) and (2).

Therefore, as illustrated in FIG. 5B, in a case where peaks of the correlation value of the blocks 151 and 155 appear in every cycle dw, as illustrated in FIG. 5A, peaks of the correlation value of the blocks 151 and 153 appear in every cycle which is a half of the cycle dw. That is, when the base line length between the reference camera 100 and the peripheral camera is doubled, the cycle of the peaks of the correlation value becomes a half which is the reciprocal of double. Also, a phase of the peak of the correlation value of the blocks 151 and 153 is synchronized with a phase of the peak of the correlation value of the blocks 151 and 155.

According to the above, as illustrated in FIG. 5C, the peak with a large total correlation value obtained by adding the correlation value of the blocks 151 and 153 to the correlation value of the blocks 151 and 155 appears at the same disparity value D as that of the peak of the correlation value of the blocks 151 and 155. That is, the cycle of the peaks with the large total correlation value is a cycle dw which is the least common multiple of the cycle ½dw and the cycle dw.

FIGS. 6A to 6C are diagrams of exemplary correlation values of the blocks 151 and 153 and the blocks 151 and 155 in a case where the base line length X₁ is three halves of the base line length X₂.

Furthermore, FIG. 6A is a graph of a correlation value of the blocks 151 and 153, and FIG. 6B is a graph of a correlation value of the blocks 151 and 155. FIG. 6C is a graph of a total correlation value obtained by adding the correlation value of the blocks 151 and 153 to the correlation value of the blocks 151 and 155.

In a case where the base line length X₁ is three halves of the base line length X₂, the x coordinate x₁ of the block 153 moves by 3/2xᵣ if the x coordinate x₂ of the block 155 moves by xᵣ according to the above-described formulas (1) and (2).

Therefore, in a case where the peaks of the correlation value of the blocks 151 and 155 appear in every cycle dw as illustrated in FIG. 6B, the peaks of the correlation value of the blocks 151 and 153 appear in every cycle ⅔ dw as illustrated in FIG. 6A. That is, if the base line length between the reference camera 100 and the peripheral camera becomes 3/2, the cycle of the peaks of the correlation value becomes ⅔ which is the reciprocal of 3/2. Also, a phase of the peak of the correlation value of the blocks 151 and 153 is synchronized with a phase of the peak of the correlation value of the blocks 151 and 155.

According to the above, as illustrated in FIG. 6C, the peak with a large total correlation value obtained by adding the correlation value of the blocks 151 and 153 and the correlation value of the blocks 151 and 155 appears in every cycle 2dw which is twice the cycle dw of the peaks of the correlation value of the blocks 151 and 155. That is, the cycle of the peaks with the large total correlation value is the cycle 2dw which is the least common multiple of the cycle ⅔ dw and the cycle dw. The cycle 2dw is equal to the cycle of the peaks of the correlation value of the captured images of the peripheral camera and the reference camera 100 of which the base line length is half of the base line length X₂.

Furthermore, in FIGS. 5A to 5C and 6A to 6C, the correlation values of the peripheral camera 101 and the peripheral camera 102 have been described. However, the correlation values of the other two peripheral cameras are similar to the above correlation value.

As described above, in a case where a vertically-striped repetitive pattern exists in the captured image 140, a reciprocal of a ratio of the base lire lengths Xₙ of the reference camera 100 and the peripheral cameras 101 to 107 in the horizontal direction is a ratio of the cycles of the peaks of the correlation values. Also, the least common multiple of the cycles of the peaks of the correlation values respectively corresponding to the peripheral cameras 101 to 107 is the cycle of the peaks with a large total correlation value.

Also, although not shown, in a case where a horizontally-striped repetitive pattern exists in the captured image 140, a reciprocal of a ratio of the base line lengths in the vertical direction Yₙ of the reference camera 100 and the peripheral cameras 101 to 107 is a ratio of the cycles of the peaks of the correlation values, similar to a case where the vertically-striped repetitive pattern exists. Also, the least common multiple of the cycles of the peaks of the correlation values respectively corresponding to the peripheral cameras 101 to 107 is the cycle of the peaks with a large total correlation value.

Therefore, the present technology lengthens a generation cycle of peaks with a large total correlation value without reducing the base line length by differentiating at least one of ratios of the base line lengths between the reference camera and the peripheral cameras in the horizontal direction and the vertical direction. This can reduce the widths xwₙ and ywₙ so that the width of the repetitive pattern becomes larger than the widths xwₙ and ywₙ without reducing the accuracy of triangulation of the disparity value. As a result, incorrect recognition of the depth estimation caused by the repetitive pattern does not occur, and the depth can be estimated with high accuracy.

Here, as described above, the cycle of the peaks with a large total correlation value is the least common multiple of the peaks of the correlation values corresponding to the respective peripheral cameras. Therefore, by making the ratio of the cycles of the peaks of the correlation values corresponding to the respective peripheral cameras be closer to the prime number ratio, the cycle of the peaks with a large total correlation value can be efficiently prolonged.

For example, if the cycles of the peaks of the correlation values respectively corresponding to four peripheral cameras are double, triple, quintuple, and septuple of the cycle dws, the cycle of the peaks with a large total correlation value becomes 210 (=2×3×5×7) times of the cycle dws. Also, as described above, the ratio of the cycles of the peaks of the correlation values of the respective peripheral cameras is the reciprocal of the ratio of the base line lengths of the reference camera 100 and the peripheral cameras. Therefore, in a case where the ratio of the cycles of the peaks of the correlation values corresponding to the respective peripheral cameras is 2:3:5:7, the ratio of the base line lengths of the reference camera 100 and the peripheral cameras is 1/2:1/3:1/5:1/7.

At this time, the base line length corresponding to the cycle of the peaks with a large total correlation value is 1/210 (=½×3×5×7)) of the base line length corresponding to the cycle dws, that is, 1/30 (=( 1/210)/( 1/7)) of the actual shortest base line length between the reference camera and the peripheral camera. Therefore, a limit spatial frequency in which the incorrect recognition of the depth estimation is caused by the repetitive pattern can be improved 30 times.

### FIRST EMBODIMENT

(Exemplary Configuration of one Embodiment of Light Field Camera)

FIG. 7 is a block diagram of an exemplary configuration of one embodiment of a light field camera as an image pickup device to which the present disclosure has been applied.

A light field camera 200 in FIG. 7 includes an imaging unit 201 and an image processing unit 202. The light field camera 200 generates a virtual focus captured image as a refocus image from captured images obtained by a plurality of cameras.

Specifically, the imaging unit 201 of the light field camera 200 includes a single reference camera (imaging unit), a plurality of other peripheral cameras (imaging unit), and the like. The reference camera is a reference in a case where images are captured from different viewpoints. The peripheral cameras are respectively arranged according to the base line length on the basis of the reciprocals of different prime numbers while having the position of The reference camera as the reference.

The reference camera and the peripheral cameras capture images from different viewpoints. The imaging unit 201 supplies a block including one or more pixels from among captured images (light ray information) captured by the reference camera and the peripheral cameras to the image processing unit 202 in response to a request from the image processing unit 202. Also, the imaging unit 201 supplies the captured images captured by the reference camera and the peripheral cameras to the image processing unit 202.

The image processing unit 202 is, for example, configured of a large scale integration (LSI). The image processing unit 202 includes a detection unit 211, a virtual viewpoint image generating unit 212, and a refocus image generating unit 213.

The detection unit 211 (depth estimating unit) estimates the depth of the image of the reference camera, for example, for each pixel, by using the block of the captured image of the reference camera supplied from the imaging unit 201 and the block of the captured image of each peripheral camera.

Specifically, the detection unit 211 determines pixels of the captured image of the reference camera as a pixel to be processed in order. The detection unit 211 requests the imaging unit 201 to supply the block of the captured image of the reference camera including the pixel to be processed and the block of the captured image of each peripheral camera corresponding to the disparity value for each disparity value to be a candidate. The detection unit 211 performs block matching to each peripheral camera by using the block of the captured image of the reference camera and the block of the captured image of each peripheral camera to be supplied from the imaging unit 201 in response to the request. With the above processing, the detection unit 211 obtains the correlation value corresponding to each disparity value for each peripheral camera and each pixel.

Then, the detection unit 211 obtains a total correlation value by adding the correlation values of all the peripheral cameras for each disparity value of each pixel. The detection unit 211 determines the disparity value having the largest total correlation value as a depth estimation result for each pixel. The detection unit 211 supplies a parallax image formed by using the depth estimation result of each pixel to the virtual viewpoint image generating unit 212 as a parallax image from a viewpoint of the reference camera.

The virtual viewpoint image generating unit 212 (generation unit) generates a parallax image from a viewpoint of the peripheral camera by using the parallax image from the viewpoint of the reference camera supplied from the detection unit 211. The virtual viewpoint image generating unit 212 interpolates a captured image from a virtual viewpoint (light ray information) other than the viewpoints of the reference camera and the peripheral cameras by using the generated parallax image from each viewpoint and the captured image from each viewpoint supplied from the imaging unit 201. Specifically, for example, the virtual viewpoint image generating unit 212 interpolates the captured image from the virtual viewpoint by using the parallax image from the viewpoints around the virtual viewpoint and the captured image.

The virtual viewpoint image generating unit 212 supplies the captured image from each viewpoint supplied from the imaging unit 201 and the captured image from the virtual viewpoint to the refocus image generating unit 213 as a super multi-viewpoint image (light ray group information) with high-density viewpoints.

The refocus image generating unit 213 generates a virtual focus captured image as a refocus image by using the super multi-viewpoint image supplied from the virtual viewpoint image generating unit 212. The refocus image generating unit 213 outputs the generated refocus image.

(Exemplary Configuration of Imaging Unit)

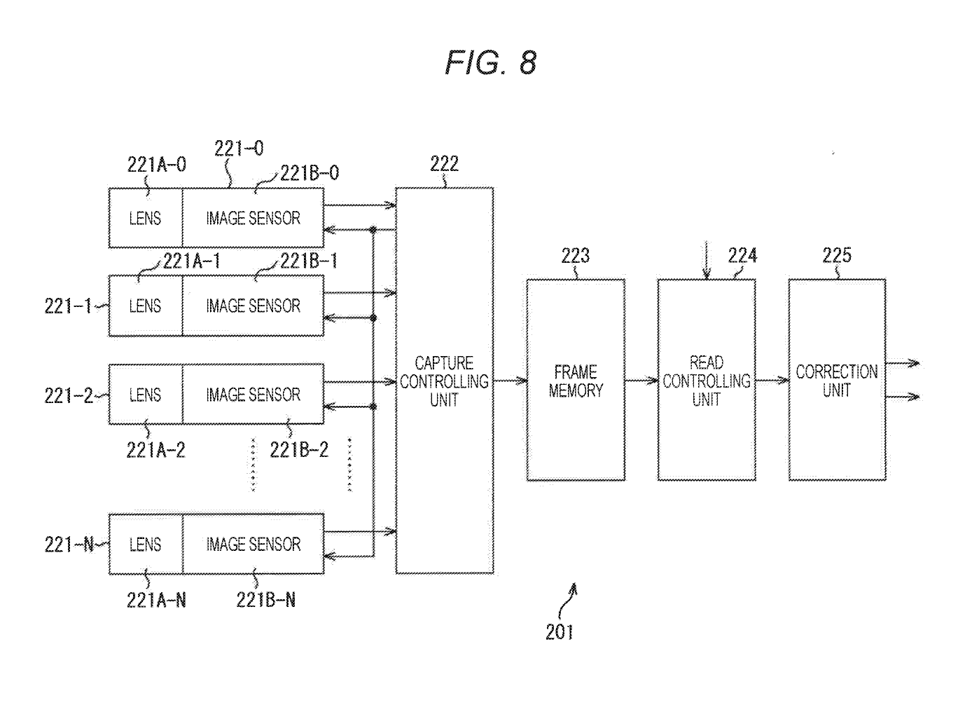

FIG. 8 is a block diagram of an exemplary configuration of the imaging unit 201 in FIG. 7.

The imaging unit 201 in FIG. 8 includes a reference camera 221-0, N (N is an integer equal to or larger than two) peripheral cameras 221-1 to 221-N, a capture controlling unit 222, a frame memory 223, a read controlling unit 224, and a correction unit 225.

The reference camera 221-0 includes a lens 221A-0 and an image sensor 221B-0 such as a charge coupled device (CCD) and a complementary metal-oxide semiconductor (CMOS). The reference camera 221-0 images an image according to a synchronization signal supplied from the capture controlling unit 222.

Specifically, the reference camera 221-0 receives light entered from an object by the image sensor 221B-0 via the lens 221A-0 according to the synchronization signal and images an image by performing A/D conversion and the like relative to an analog signal which is obtained as a result of the reception of the light. The reference camera 221-0 supplies the captured image obtained by imaging the image to the capture controlling unit 222.

The peripheral cameras 221-1 to 221-N are formed similarly to the reference camera 221-0 and respectively image images according to the synchronization signal from the capture controlling unit 222. The peripheral cameras 221-1 to 221-N respectively supply the captured images obtained by imaging the image to the capture controlling unit 222.

The capture controlling unit 222 obtains the captured images from different viewpoints and at the same time by supplying the same synchronization signal to the reference camera 221-0 and the peripheral cameras 221-1 to 221-N. The capture controlling unit 222 supplies the obtained captured images from different viewpoints and at the same time to the frame memory 223 (storage unit) and makes the frame memory 223 store the supplied images.

The read controlling unit 224 controls reading so that a predetermined block from among the captured images of the reference camera 221-0 and the peripheral cameras 221-1 to 221-N is read from the frame memory 223 in response to the request from the detection unit 211 in FIG. 7. The read controlling unit 224 supplies the read block to the correction unit 225. Also, the read controlling unit 224 reads the captured images of the reference camera 221-0 and the peripheral cameras 221-1 to 221-N from the frame memory 223 and supplies the read images to the correction unit 225.

The correction unit 225 performs correction processing to the block and the captured images supplied from the read controlling unit 224. For example, the correction processing is black level correction, distortion correction, and shading correction. The correction unit 225 supplies the block to which the correction processing has been performed to the detection unit 211 in FIG. 7 and supplies the captured image to which the correction processing has been performed to the virtual viewpoint image generating unit 212.

Furthermore, it is preferable that the reference camera 221-0 (imaging unit) and the peripheral cameras 221-1 to 221-N (imaging unit) do not include the lenses 221A-0 to 221A-N. In this case, the imaging unit 201 includes the lenses 221A-0 to 221A-N arranged to be separated from the reference camera 221-0 and the peripheral cameras 221-1 to 221-N.

(First Arrangement Example of Reference Camera and Peripheral Cameras)

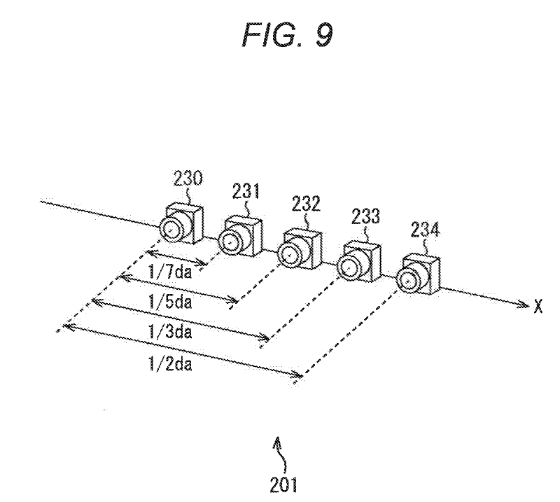

FIG. 9 is a perspective diagram of a first arrangement example of the reference camera 221-0 and the peripheral cameras 221-1 to 221-N of the imaging unit 201 in FIG. 7.

In an imaging unit 201 in FIG. 9, a single reference camera 230 as the reference camera 221-0 and four peripheral cameras 231 to 234 as the peripheral cameras 221-1 to 221-1 are aligned in the horizontal direction.

Also, distances between the reference camera 230 and the peripheral cameras 231 to 234 in the horizontal direction, that is, base line lengths between the reference camera 230 and the peripheral cameras 231 to 234 in the horizontal direction are values obtained by multiplying reciprocals of different prime numbers by a predetermined value da. Specifically, the base line lengths between the reference camera 230 and the peripheral cameras 231 to 234 in the horizontal direction are 1/7 da, ⅕ da, ⅓ da, and ½ da.

In this case, if a vertically-striped repetitive pattern exists in the captured image of the reference camera 230, the cycle of the peaks with a large total correlation value is 210 (=2×3×5×7) times as much as the peak of the correlation value of the captured images of the peripheral cameras and the reference camera 230 of which the base line length in the horizontal direction is the predetermined value da. That is, the cycle of the peaks with a large total correlation value is 30 times as much as the cycle of the peaks of the correlation value of the captured images of the peripheral camera 231 and the reference camera 230 of which the base line length (horizontal base line length) with the reference camera 230 in the horizontal direction is 1/7 da which is the shortest. Therefore, the limit spatial frequency in which the incorrect recognition of the depth estimation is caused by the repetitive pattern in the horizontal direction can be improved 30 times.

Also, if the base line length between the reference camera 230 and each of the peripheral cameras 231 to 234 in the horizontal direction is a value obtained by multiplying a value close to the reciprocal of the prime number by the predetermined value da, it is not necessary for the base line length to be a value obtained by multiplying the reciprocal of the prime number by the predetermined value da.

Also, although not shown in FIG. 9, the reference camera and the peripheral cameras may be arranged in one direction such as the vertical direction and the oblique direction other than the horizontal direction. In a case where the reference camera and the peripheral cameras are arranged in the vertical direction, the incorrect recognition of the depth estimation caused by the repetitive pattern in the vertical direction can be prevented. Also, in a case where the cameras are arranged in the oblique direction, incorrect recognition of the depth estimation caused by the repetitive pattern in the oblique direction in addition to the horizontal direction and the vertical direction can be prevented.

(Second Arrangement Example of Reference Camera and Peripheral Cameras)

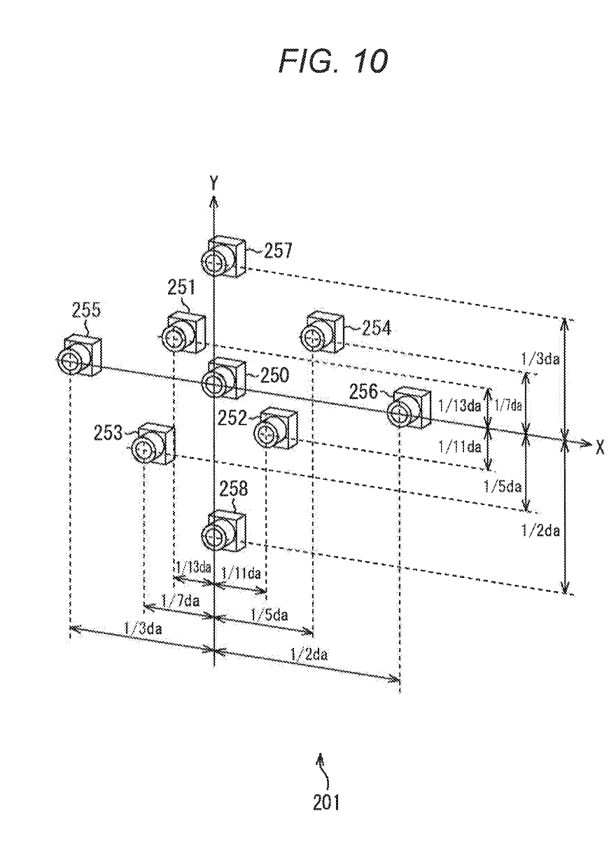

FIG. 10 is a perspective diagram of a second arrangement example of the reference camera 221-0 and the peripheral cameras 221-1 to 221-N of the imaging unit 201 in FIG. 7.

In an imaging unit 201 in FIG. 10, a single reference camera 250 as the reference camera 221-0 and eight peripheral cameras 251 to 258 as the peripheral cameras 221-1 to 221-N are two-dimensionally arranged.

Also, distances between the reference camera 250 and the peripheral cameras 251 to 256 in the horizontal direction, that is, base line lengths between the reference camera 250 and the peripheral cameras 251 and 256 in the horizontal direction are values obtained by multiplying reciprocals of different prime numbers by the predetermined value da. Specifically, the base line lengths between the reference camera 250 and the peripheral cameras 251 to 258 in the horizontal direction are 1/13 da, 1/11 da, 1/7 da, ⅕ da, ⅓ da, and ½ da.

Also, distances between the reference camera 250 and the peripheral cameras 251 to 254, 257, and 258 in the vertical direction, that is, base line lengths (vertical base line length) between the reference camera 250 and the peripheral cameras 251 to 254, 257, and 258 in the vertical direction are values obtained by multiplying reciprocals of different prime numbers by the predetermined value da. Specifically, the base line lengths between the reference camera 250 and the peripheral cameras 251 to 254, 257, and 258 in the vertical direction are respectively 1/13 da, 1/11 da, ⅕ da, 1/7 da, ⅓ da, ½ da.

In this case, if a vertically-striped repetitive pattern exists in the captured image of the reference camera 250, the cycle of the peaks with a large total correlation value is 30030 (=2×3×5×7×11×13) times as much as that of the peaks of the correlation value of the captured images of the peripheral cameras and the reference camera 250 of which the base line length in the horizontal direction is the predetermined value da. That is, the cycle of the peaks with a large total correlation value is 2310 times as much as the cycle of the peaks of the correlation value of the captured images of the peripheral camera 251 of which the base line length with the reference camera 250 in the horizontal direction is 1/13 da which is the shortest and the reference camera 250. Therefore, the limit spatial frequency in which the incorrect recognition of the depth estimation is caused by the repetitive pattern in the horizontal direction can be improved 2310 times.

Similarly, the limit spatial frequency in which the incorrect recognition of the depth estimation is caused by the repetitive pattern in the vertical direction can be also improved 2310 times.

Also, if the base line length between the reference camera 250 and each of the peripheral cameras 251 to 258 in the horizontal direction and the vertical direction is a value obtained by multiplying a value close to the reciprocal of the prime number by the predetermined value da, it is not necessary for the base line length to be a value obtained by multiplying the reciprocal of the prime number by the predetermined value da.

(Third Arrangement Example of Reference Camera and Peripheral Cameras)

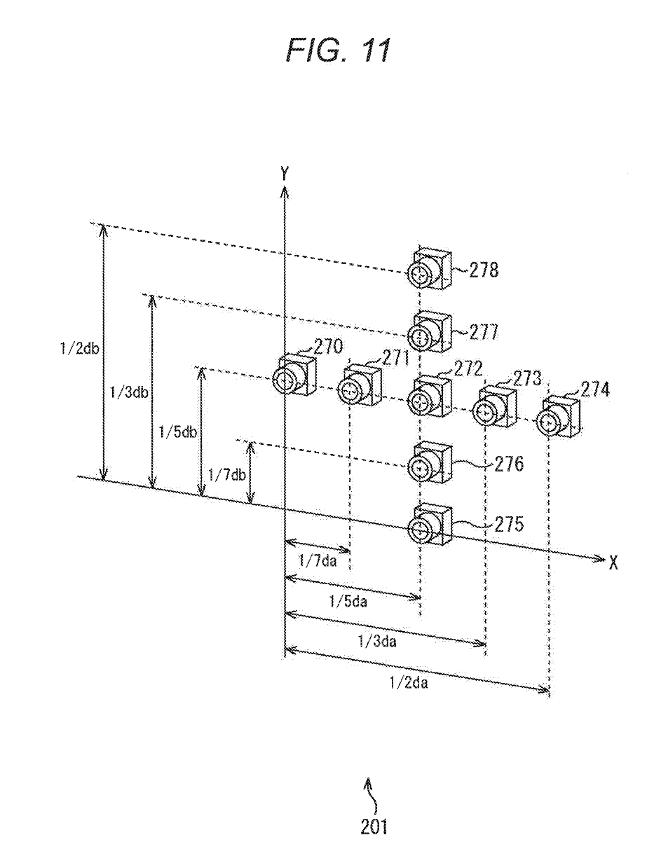

FIG. 11 is a perspective diagram of a third arrangement example of the reference camera 221-0 and the peripheral cameras 221-1 to 221-N of the imaging unit 201 in FIG. 7.

In an imaging unit 201 in FIG. 11, a single reference camera 270 as the reference camera 221-0 and eight peripheral cameras 271 to 278 as the peripheral cameras 221-1 to 221-N are arranged in a cross shape. Specifically, while the peripheral camera 272 is positioned at the center, the reference camera 270 and the peripheral cameras 271 to 274 are arranged in the horizontal direction, and the peripheral cameras 272 and 275 to 278 are arranged in the vertical direction.

Also, base line lengths between the reference camera 270 and the peripheral cameras 271 to 274 in the horizontal direction are values obtained by multiplying reciprocals of different prime numbers by the predetermined value da. Specifically, the base line lengths between the reference camera 270 and the peripheral cameras 271 to 274 in the horizontal direction are 1/7 da, ⅕ da, ⅓ da, and ½ da.

Also, base line lengths between the peripheral camera 275 and the peripheral cameras 272 and 276 to 278 in the vertical direction are values obtained by multiplying reciprocals of different prime numbers by a predetermined value db. Specifically, the base line lengths between the peripheral camera 275 and the peripheral cameras 272 and 276 to 278 in the vertical direction are ⅕ db, 1/7 db, ⅓ db, and ½ db.

In this case, generation of incorrect recognition of the depth estimation caused by the repetitive pattern not only in the horizontal direction and the vertical direction but also in all directions can be prevented.

Also, if the base line length between the reference camera 270 and each of the peripheral cameras 271 to 274 in the horizontal direction is a value obtained by multiplying a value close to the reciprocal of the prime number by the predetermined value da, it is not necessary for the base line length to be a value obtained by multiplying the reciprocal of the prime number by the predetermined value da. Similarly, if the base line lengths between the peripheral camera 275 and the peripheral cameras 272 and 276 to 278 in the vertical direction are values obtained by multiplying a value close to the reciprocal of the prime number by the predetermined value da, it is not necessary for the base line length to be the value obtained by multiplying the reciprocal of the prime number by the predetermined value da.

(Fourth Arrangement Example of Reference Camera and Peripheral Cameras)

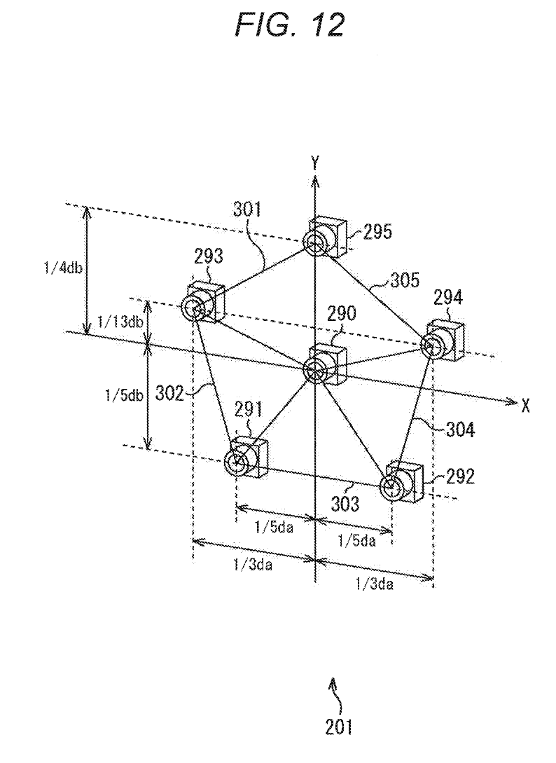

FIG. 12 is a perspective diagram of a fourth arrangement example of the reference camera 221-0 and the peripheral cameras 221-1 to 221-N of the imaging unit 201 in FIG. 7.

In an imaging unit 201 in FIG. 12, five peripheral cameras 291 to 295 as the peripheral cameras 221-1 to 221-N are arranged in a shape of a regular pentagon around a single reference camera 290 as the reference camera 221-0.

Also, base line lengths between the reference camera 290 and the peripheral cameras 291 to 294 in the horizontal direction are values obtained by multiplying reciprocals of prime numbers by the predetermined value da. Specifically, the has line length between the reference camera 290 and each of the peripheral cameras 291 and 292 in the horizontal direction is ⅕ da, and the base line length between the reference camera 290 and each of the peripheral cameras 293 and 294 in the horizontal direction is ⅓ da. Also, the position of the peripheral camera 295 in the horizontal direction is the same as that of The reference camera 290 in the horizontal direction.

Also, base line lengths between the reference camera 290 and the peripheral cameras 291 to 294 in the vertical direction are values obtained by multiplying reciprocals of prime numbers by a predetermined value db. Specifically, the base line length between the reference camera 290 and each of the peripheral cameras 291 and 292 in the vertical direction is ⅕db, and the base line length between the reference camera 290 and each of the peripheral cameras 293 and 294 in the vertical direction is 1/13 db. The base line length between the reference camera 290 and the peripheral camera 295 in the vertical direction is ¼ db.

As illustrated in FIG. 12, in a case where the five peripheral cameras 291 to 295 are arranged in a shape of a regular pentagon with the reference camera 290 as the center, most of the base line lengths in the horizontal direction and the vertical direction are values obtained by multiplying a reciprocal of a prime number by a predetermined value. Therefore, incorrect recognition of the depth estimation caused by the repetitive patterns in the horizontal direction and the vertical direction can be prevented.

Also, regarding triangles formed by connecting three adjacent cameras of the reference camera 290 and the peripheral cameras 291 to 295, triangles 301 to 305 formed by connecting the reference camera 290 and the two adjacent peripheral cameras are the same. Therefore, the virtual viewpoint image generating unit 212 can interpolate the captured image from the virtual viewpoint regardless of the position of the virtual viewpoint with a method for interpolating the captured image from the virtual viewpoint by using a captured image and a parallax image from the viewpoint of the camera positioned at the vertex of the triangle having the same size as the triangles 301 to 305 including the virtual viewpoint. That is, it is not necessary to change the method for interpolating the captured image from the virtual viewpoint according to the position of the virtual viewpoint. Therefore, the captured image from the virtual viewpoint can be easily interpolated.

(Fifth Arrangement Example of Reference Camera and Peripheral Cameras)

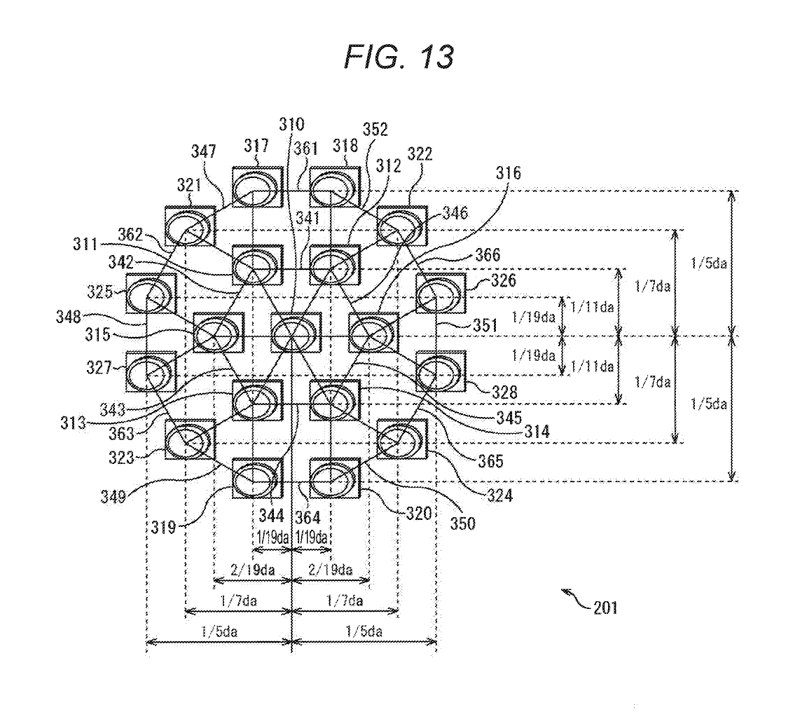

FIG. 13 is a perspective diagram of a fifth arrangement example of the reference camera 221-0 and the peripheral cameras 221-1 to 221-N of the imaging unit 201 in FIG. 7.

In an imaging unit 201 in FIG. 13, a single reference camera 310 as the reference camera 221-0 and 18 peripheral cameras 311 to 328 as the peripheral cameras 221-1 to 221-N are arranged. Specifically, the peripheral cameras 311 to 316 are arranged in a shape of a regular hexagon around the reference camera 310, and the peripheral cameras 317 to 320 are arranged in a shape of a regular dodecagon around the reference camera 310. The length of each side of the regular hexagon is equal to that of the regular dodecagon.

Also, the base line length between the reference camera 310 and each of the peripheral cameras 311 to 314 and 317 to 328 in the horizontal direction is a value obtained by multiplying a reciprocal of a prime number by a predetermined value da.

Specifically, the base line length between the reference camera 310 and each of the peripheral cameras 311 to 314 and 317 to 320 in the horizontal direction is 1/19 da, and the base line length between the reference camera 310 and each of the peripheral cameras 321 to 324 in the horizontal direction is 1/7 da. Also, the base line length between the reference camera 310 and each of the peripheral cameras 325 to 328 in the horizontal direction is ⅕ da. Also, the base line length between the reference camera 310 and each of the peripheral cameras 315 and 316 in the horizontal direction is 2/19 da.

The base line length between the reference camel 310 and each of the peripheral cameras 311 to 328 in the vertical direction is a value obtained by multiplying a reciprocal of a prime number by a predetermined value da. Specifically, the base line length between the reference camera 310 and each of the peripheral cameras 325 to 326 in the vertical direction is 1/19 da, and the base line length between the reference camera 310 and each of the peripheral cameras 311 to 314 in the vertical direction is 1/11 da.

Also, the base line length between the reference camera 310 and each of the peripheral cameras 321 to 324 in the vertical direction is 1/7 da, and the base line length between the reference camera 310 and each of the peripheral cameras 317 to 320 in the vertical direction is ⅕ da.

As illustrated in FIG. 13, in a case where the peripheral cameras 311 to 316 are arranged in a shape of a regular hexagon around the reference camera 310 and the peripheral cameras 317 to 328 are arranged in a shape of a regular dodecagon around the reference camera 310, most of the base line lengths in the horizontal direction and the vertical direction are values obtained by multiplying reciprocals of prime numbers by a predetermined value. Therefore, incorrect recognition of the depth estimation caused by the repetitive patterns in the horizontal direction and the vertical direction can be prevented.

Also, regarding triangles formed by connecting three adjacent cameras of the reference camera 310 and the peripheral cameras 311 to 328, triangles 341 to 346 formed by connecting the reference camera 310 and two adjacent cameras of the peripheral cameras 311 to 316 and triangles 347 to 352 formed by connecting one of the peripheral cameras 311 to 316 and adjacent two cameras of the peripheral cameras 317 to 328 are the same regular triangles.

In addition, regarding quadrangles formed by connecting four adjacent cameras, quadrangles 361 to 366 formed by connecting two adjacent cameras of the peripheral cameras 311 to 316 and two of the peripheral cameras 317 to 328 opposed to the two adjacent cameras are the same squares.

Therefore, there are needed two kinds of methods for interpolating the virtual viewpoint by the virtual viewpoint image generating unit 212. A first interpolation method is a method for interpolating a captured image from the virtual viewpoint by using the captured image and the parallax image from the viewpoint of the camera positioned at the vertex of a regular triangle having a common size to the triangles 341 to 352 including the virtual viewpoint. A second interpolation method is a method for interpolating a captured image from the virtual viewpoint by using the captured image and the parallax image from the viewpoint of the camera positioned at the vertex of a square having a common size to the quadrangles 361 to 366 including the virtual viewpoint. According to the above methods, the captured image from the virtual viewpoint can be easily interpolated.

Also, since the lengths of the respective sides of the triangles 341 to 352 and the quadrangles 361 to 366 are the same, the captured image from the virtual viewpoint can be interpolated with a uniform density.

(Description of Arrangement of Reference Camera and Peripheral Cameras and Effect)

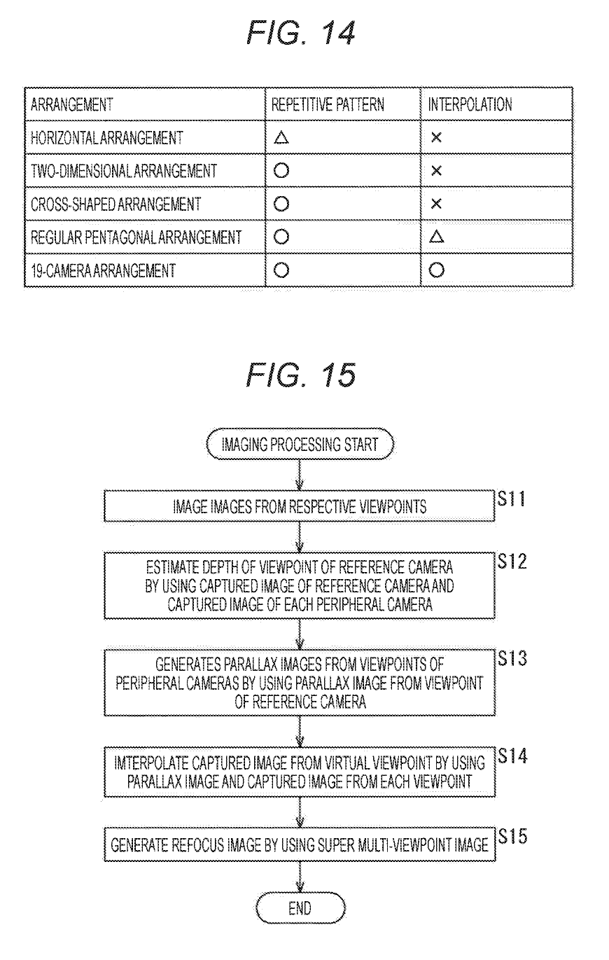

FIG. 14 is a chart to describe the first to fifth arrangement examples of the reference camera and the peripheral cameras respectively illustrated in FIGS. 9 to 13 and effects obtained by the above arrangements.

In the chart in FIG. 14, the names of the arrangements respectively illustrated in FIGS. 9 to 13 are written in the left column, and the degree of the effect relative to the incorrect recognition of the depth estimation caused by the repetitive pattern is written in the center column. Also, the degree of the effect relative to the interpolation of the captured image from the virtual viewpoint is written in the right column. Note that the first to fifth arrangement examples are respectively referred to as horizontal arrangement, two-dimensional arrangement, cross-shaped arrangement, regular pentagonal arrangement, and 19-camera arrangement below.

In a case where the arrangement of the reference camera and the peripheral cameras of the imaging unit 201 is the horizontal arrangement in FIG. 9, the incorrect recognition of the depth estimation caused by the repetitive pattern in the horizontal direction can be prevented. However, the horizontal arrangement does not have an effect to prevent incorrect recognition of the depth estimation caused by the repetitive pattern in the vertical direction. Therefore, in the second row of the center column in the chart illustrated in FIG. 14, a triangle indicating “middle” is written as the degree of the effect relative to the incorrect recognition of the depth estimation caused by the repetitive pattern.

On the other hand, in a case where the arrangement of the reference camera and the peripheral cameras of the imaging unit 201 is the two-dimensional arrangement in FIG. 10, the cross-shaped arrangement in FIG. 11, the regular pentagonal arrangement in FIG. 12, and the 19-camera arrangement in FIG. 13, the incorrect recognition of the depth estimation ceased by the repetitive patterns in the horizontal direction and the vertical direction can be prevented. Therefore, in the third to sixth rows of the center column in the chart illustrated in FIG. 14, circles indicating “high” are written as the degree of the effect relative to the incorrect recognition of the depth estimation caused by the repetitive pattern.

Also, in a case where the arrangement of the reference camera and the peripheral cameras of the imaging unit 201 is the horizontal arrangement in FIG. 9, all the distances between adjacent cameras are different from each other. In addition, in a case where the arrangement of the reference camera and the peripheral cameras of the imaging unit 201 is the two-dimensional arrangement in FIG. 10 and the cross-shaped arrangement in FIG. 11, all the shapes formed by connecting three or more adjacent cameras of the reference camera and the peripheral cameras are different from each other. Therefore, an effect to interpolate the captured image from the virtual viewpoint is not obtained. Therefore, in the two to four rows of the right column in the chart illustrated in FIG. 14, cross marks indicating “none” are written as the degree of the effect relative to the interpolation of the captured image from the virtual viewpoint.

In addition, in a case where the arrangement of the reference camera and the peripheral cameras of the imaging unit 201 is the regular pentagonal arrangement in FIG. 12 and the 19-camera arrangement in FIG. 13, at least a part of shapes formed by connecting three or more adjacent cameras of the reference camera and the peripheral cameras are the same. Therefore, the kinds of the method for interpolating the captured image from the virtual viewpoint may be small, and the captured image from the virtual viewpoint can be easily interpolated.

However, since the triangles 301 to 305 are not regular triangles in the regular pentagonal arrangement in FIG. 12, the captured image from the virtual viewpoint cannot be interpolated with a uniform density. Therefore, in the fifth row of the right column in the chart illustrated in FIG. 14, a triangle indicating “middle” is written as the degree of the effect relative to the interpolation of the captured image from the virtual viewpoint.

Whereas, in the 19-camera arrangement in FIG. 13, the lengths of the respective sides of the triangles 341 to 352 and the quadrangles 361 to 366 are the same. Therefore, the captured image from the virtual viewpoint can be interpolated with a uniform density. Therefore, in the sixth row of the right column in the chart illustrated in FIG. 14, a circle indicating “high” is written as the degree of the effect relative to the interpolation of the captured image from the virtual viewpoint.

As described above, the light field camera 200 includes the reference camera and the plurality of peripheral cameras for imaging the images from different viewpoints, and the distances between the reference camera and at least two peripheral cameras in at least one direction are values respectively obtained by multiplying reciprocals of different prime numbers by a predetermined value. Therefore, the depth of the captured image including a repetitive pattern at least in one direction can be estimated with high accuracy. As a result, accuracy of a refocus image is improved.

Whereas, in a case where the cameras are arranged at constant intervals in the horizontal direction and the vertical direction, that is, in a case where the cameras are arranged in a lattice pattern, it is difficult to estimate the depth of the captured image having the repetitive pattern with high accuracy.

Furthermore, resolutions of the reference camera and the peripheral cameras may be the same and may be different from each other. In a case where the resolution of the reference camera is different from that of the peripheral camera, the disparity value can be obtained for each sub-pixel.

Also, the number of the peripheral cameras is not limited to the numbers described above. The incorrect recognition of the depth estimation caused by finer repetitive patterns can be prevented with an increase in the number of peripheral cameras. In addition, the predetermined values da and db can be set to arbitrary values.

(Description of Processing of Light Field Camera)

FIG. 15 is a flowchart to describe imaging processing performed by the light field camera 200 in FIG. 7.

In step S11 in FIG. 15, the reference camera 221-0 and the peripheral cameras 221-1 to 221-N (FIG. 8) of the imaging unit 201 of the light field camera 200 image images from respective viewpoints at the same time according to the synchronization signal from the capture controlling unit 222. The captured image obtained as a result of the above processing is stored in the frame memory 223 via the capture controlling unit 222.

Then, the read controlling unit 224 read a predetermined block of the captured images imaged by the reference camera 221-0 and the peripheral cameras 221-1 to 221-N from the frame memory 223 in response to the request from the detection unit 211. Also, the read controlling unit 224 reads the captured images of the reference camera 221-0 and the peripheral cameras 221-1 to 221-N from the frame memory 223. The block read from the frame memory 223 is supplied to the detection unit 211 via the correction unit 225, and the captured images read from the frame memory 223 are supplied to the virtual viewpoint image generating unit 212 via the correction unit 225.

In step S12, the detection unit 211 estimates the depth of the viewpoint of the reference camera 221-0, for example, for each pixel by using the block of the captured image of the reference camera 221-0 supplied from the correction unit 225 and the block of the captured image of each of the peripheral cameras 221-1 to 221-N. The detection unit 211 supplies the parallax image formed by the depth estimation result of each pixel to the virtual viewpoint image generating unit 212 as a parallax image from the viewpoint of the reference camera 221-0.

In step S13, the virtual viewpoint image generating unit 212 generates parallax images from the viewpoints of the peripheral cameras 221-1 to 221-N by using the parallax image from the viewpoint of the reference camera 221-0 supplied from the detection unit 211.

In step S14, the virtual, viewpoint image generating unit 212 interpolates the captured image from the virtual viewpoint by using the generated parallax image from each viewpoint and the captured image from each viewpoint supplied from the correction unit 225. The virtual viewpoint image generating unit 212 supplies the captured image from each viewpoint supplied from the correction unit 225 and the captured image from the virtual viewpoint to the refocus image generating unit 213 as a super multi-viewpoint image of high-density viewpoint.

In step S15, the refocus image generating unit 213 generates a virtual focus captured image as a refocus image by using the super multi-viewpoint image supplied from the virtual viewpoint image generating unit 212. The refocus image generating unit 213 outputs the generated refocus image, and the processing is terminated.

### SECOND EMBODIMENT

(Description on Computer to Which the Present Disclosure is Applied)

The above-mentioned series of processing can be executed by hardware and software. In a case where the series of the processing is executed by the software, a program included in the software is installed in a computer. Here, the computer includes a computer incorporated in dedicated hardware and, for example, a general personal computer which can perform various functions by installing various programs.

FIG. 16 is a block diagram of an exemplary configuration of hardware of the computer for executing the above-mentioned series of processing by the program.

In a computer 400, a central processing unit (CPU) 401, a read only memory (ROM) 402, and a random access memory (RAM) 403 are connected to each other with a bus 404.

In addition, an input/output interface 405 is connected to the bus 404. An imaging unit 406, an input unit 407, an output unit 408, a storage unit 409, a communication unit 410, and a drive 411 are connected to the input/output interface 405.

The imaging unit 406 is configured similarly to the imaging unit 201 in FIG. 7. The input unit 407 includes a keyboard, a mouse, a microphone, and the like. The output unit 408 includes a display, a speaker, and the like. The storage unit 409 includes a hard disk, a non-volatile memory, and the like. The communication unit 410 includes a network interface and the like. The drive 411 drives a removable medium 412 such as a magnetic disk, an optical disk, an optical magnetic disk, or a semiconductor memory.

In the computer 400 configured as above, the CPU 401 loads, for example, the program stored in the storage unit 409 to the RAM 403 via the input/output interface 405 and the bus 404 and executes the program so that the above-mentioned series of processing is executed.

The program executed by the computer 400 (CPU 401), for example, can be provided by recording it to the removable medium 412 as a package medium and the like. Also, the program can be provided via a wired or wireless transmission media such as a local area network, the internet, and a digital satellite broadcast.

In the computer 400, the program can be installed to the storage unit 409 via the input/output interface 405 by mounting the removable medium 412 in the drive 411. Also, the program can be received by the communication unit 410 via the wired or wireless transmission media and installed to the storage unit 409. In addition, the program can be previously installed to the ROM 402 and the storage unit 409.

Note that, the program executed by the computer 400 may be a program in which processing is performed along the order described herein in a time series manner and a program in which the processing is executed in parallel or at a necessary timing when a call has been performed.

<Modification>

The technology according to the present disclosure can be applied to various products. For example, the technology according to the present disclosure may be realized as a device to be mounted to any one of vehicles such as an automobile, an electric vehicle, a hybrid electric vehicle, and a motorcycle.

FIG. 17 is a block diagram of an exemplary schematic configuration of a vehicle control system 2000 to which the technology according to the present disclosure can be applied. The vehicle control system 2000 includes a plurality of electronic control units connected via a communication network 2010. In the example illustrated in FIG. 17, the vehicle control system 2000 includes a driving system control unit 2100, a body system control unit 2200, a battery control unit 2300, an external information detecting unit 2400, an in-vehicle information detecting unit 2500, and an integration control unit 2600. The communication network 2010 for connecting these control units may be an in-vehicle communication network compliant with an optional standard, for example, the controller area network (CAN), LIN (Local Interconnect Network), the local area network (LAN), or the FlexRay (registered trademark).

Each control unit includes a microcomputer which performs operation processing in accordance with various programs, a storage unit which stores the program executed by the microcomputer or a parameter used for various operations, and a driving circuit which drives devices to be controlled. Each control unit includes a network I/F to communicate with other control unit via the communication network 2010 and a communication I/F to communicate by wired or wireless communication with devices inside/outside the vehicle, a sensor, or the like. In FIG. 17, as functional configurations of the integration control unit 2600, a microcomputer 2610, a general-purpose communication I/F 2620, a dedicated communication I/F 2630, a positioning unit 2640, a beacon receiving unit 2650, an in-vehicle device I/F 2660, a sound and image output unit 2670, an in-vehicle network I/F 2680, and a storage unit 2690 are illustrated. Other control unit similarly includes a microcomputer, a communication I/F, a storage unit, and the like.

The driving system control unit 2100 controls an operation of a device relating to a driving system of the vehicle in accordance with various programs. For example, the driving system control unit 2100 functions as a control device such as a driving force generating device to generate a driving force of the vehicle such as an internal combustion engine or a driving motor, a driving force transmitting mechanism to transmit the driving force to wheels, a steering mechanism which adjusts a steering angle of the vehicle, and a braking device which generates a braking force of the vehicle. The driving system control unit 2100 may have a function as a control device such as an antilock brake system (ABS) or an electronic stability control (ESC).

The driving system control unit 2100 is connected to a vehicle condition detection unit 2110. The vehicle condition detection unit 2110 includes at least one of, for example, a gyro sensor which detects an angular velocity of a shaft rotary motion by a vehicle body, an acceleration sensor which detects an acceleration of the vehicle, and a sensor to detect an operation amount of an accelerator pedal, an operation amount of a brake pedal, a steering angle of a steering wheel, an engine speed, or a rotational speed of a wheel. The driving system control unit 2100 performs the operation processing by using the signal input from the vehicle condition detection unit 2110 and controls an internal combustion engine, a driving motor, an electric power steering device, a brake device, or the like.

The body system control unit 2200 controls operations of various devices attached to the vehicle body in accordance with various programs. For example, the body system control unit 2200 functions as a control device of a keyless entry system, a smart key system, a power window device, or various lamps such as a head lamp, a back lamp, a brake lamp, a direction indicator, or a fog lamp. In this case, a radio wave transmitted from a portable machine for substituting a key or signals of various switches may be input to the body system control unit 2200. The body system control unit 2200 receives the input of the radio wave or the signal and controls a door locking device of a vehicle, a bower window device, a lamp, and the like.

The battery control unit 2300 controls a secondary battery 2310 which is a power supply source of he driving motor according to various programs. For example, a battery device including the secondary battery 2310 inputs information about a battery temperature, a battery output voltage, a residual capacity of the battery, or the like to the battery control unit 2300. The battery control unit 2300 performs the operation processing by using these signals and controls temperature regulation of the secondary battery 2310 or controls a cooling device included in the battery device and the like.

The external information detecting unit 2400 detects external information of the vehicle including the vehicle control system 2000. For example, the external information detecting unit 2400 is connected to at least one of an imaging unit 2410 and an external information detecting section 2420. The imaging unit 2410 includes at least one of a time of flight (ToF) camera, a stereo camera, a monocular camera, an infrared camera, and other camera. The external information detecting section 2420 includes, for example, an environment sensor to detect current whether or meteorological phenomenon or a surrounding information detecting sensor to detect other vehicle, an obstacle, or a pedestrian around the vehicle including the vehicle control system 2000.

The environment sensor may be, for example, at least one of a raindrop sensor which detects rainy weather, a fog sensor which detects fog, a sunshine sensor which detects a sunshine degree, and a snow sensor which detects snow fall. The surrounding information detecting sensor may be at least one of an ultrasonic sensor, a radar apparatus, and a light detection and ranging, laser imaging detection and ranging (LIDAR) device. The imaging unit 2410 and the external information detecting section 2420 may be included as independent sensors and devices and may be a device formed by integrating a plurality of sensors and devices.

Here, in FIG. 18, an example of set positions of the imaging unit 2410 and the external information detecting section 2420 is illustrated. Each of the imaging units 2910, 2912, 2914, 2916, and 2918 is provided in at least one of, for example, a front nose, a side mirror, a rear bumper, a back door, and an upper side of a windshield in the vehicle interior of the vehicle 2900. The imaging unit 2910 provided in the front nose and the imaging unit 2918 provided on the upper side of the windshield in the vehicle interior mainly obtain images in front of the vehicle 2900. The imaging units 2912 and 2914 provided in the side mirrors mainly obtain images on the sides of the vehicle 2900. The imaging unit 2916 provided in the rear bumper or the back door mainly obtains an image on the back of the vehicle 2900. The imaging unit 2918 provided on the upper side of the windshield in the vehicle interior is mainly used to detect a preceding vehicle, a pedestrian, an obstacle, a traffic light, a traffic sign, a traffic lane, or the like.

Also, in FIG. 18, exemplary photographing ranges of the respective imaging units 2910, 2912, 2914, and 2916 are illustrated. An imaging range a indicates an imaging range of the imaging unit 2910 provided in the front nose, and imaging ranges b and c respectively indicate imaging ranges of the imaging units 2912 and 2914 provided in the side mirrors. An imaging range d indicates en imaging range of the imaging unit 2916 provided in the rear bumper or the back door. For example, image data imaged by the imaging units 2910, 2912, 2914, and 2916 is superposed so that a bird's-eye image of the vehicle 2900 viewed from above can be obtained.

External information detecting sections 2920, 2922, 2924, 2926, 2928, and 2930 respectively provided on the front, rear, side, corner, and upper side of the windshield of the vehicle interior of the vehicle 2900 may be, for example, ultrasonic sensors or radar apparatus. The external information detecting sections 2920, 2926, and 2930 provided in the front nose, the rear bumper, the back door, and the upper side of the windshield in the vehicle interior of the vehicle 2900 may be, for example, LIDAR devices. The external information detecting sections 2920 to 2930 are mainly used to detect a preceding vehicle, a pedestrian, an obstacle, or the like.

Description is continued with reference to the FIG. 17 again. The external information detecting unit 2400 makes the imaging unit 2410 image an image outside the vehicle and receives the imaged image data. Also, the external information detecting unit 2400 receives detection information from the external information detecting section 2420 connected to the external information detecting unit 2400. In a case where the external information detecting section 2420 is an ultrasonic sensor, a radar apparatus, or a LIDAR device, the external information detecting unit 2400 transmits ultrasonic waves or electromagnetic waves and receives information on the received reflected waves. The external information detecting unit 2400 may perform processing for detecting an object such as a human, a car, an obstacle, a sign, or letters on the road or distance detection processing on the basis of the received information. The external information detecting unit 2400 may perform environment recognition processing for recognizing rain, fog, a road surface condition, or the like on the basis of the received information. The external information detecting unit 2400 may calculate a distance to an object outside the vehicle on the basis of the received information.

Also, the external information detecting unit 2400 may perform image recognition processing for recognizing a human, a car, an obstacle, a sign, letters on the road, or the like or the distance recognition processing on the basis of the received image data. The external information detecting unit 2400 may generate a bird's-eye image or a panoramic image by performing processing such as distortion correction or positioning to the received image data and synthesizing the image data imaged by the different imaging units 2410. The external information detecting unit 2400 may perform viewpoint conversion processing by using the image data imaged by the different imaging units 2410.

The in-vehicle information detecting unit 2500 detects in-vehicle information. The in-vehicle information detecting unit 2500 is connected to, for example, a driver condition detection unit 2510 for detecting a condition of a driver. The driver condition detection unit 2510 may include a camera for imaging the driver, a biosensor for detecting biological information of the driver, a microphone for collecting sound in the vehicle interior, or the like. The biosensor is provided, for example, in a seat surface or a steering wheel and detects biological information of an occupant who sits on the seat or a driver who takes a steering wheel. On the basis of the detection information input from the driver condition detection unit 2510, the in-vehicle information detecting unit 2500 may calculates a fatigue degree or a concentration degree of the driver and may determine whether the driver fails asleep. The in-vehicle information detecting unit 2500 may perform processing such as noise canceling processing to the collected audio signal.

The integration control unit 2600 controls a whole operation in the vehicle control system 2000 according to various programs. The integration control unit 2600 is connected to an input unit 2800. The input unit 2800 is realized by a device, to which the occupant can perform an input operation, such as a touch panel, a button, a microphone, a switch, or a lever. The input unit 2800 may be, for example, a remote control device using infrared rays or other radio waves and may be an external connection device such as a mobile phone corresponding to the operation of the vehicle control system 2000 or a personal digital assistant (PDA). The input unit 2800 may be, for example, a camera. In this case, the occupant can input information by using a gesture. In addition, the input unit 2800 may include, for example, an input control circuit which generates an input signal on the basis of the information input by the occupant and the like by using the input unit 2300 and outputs the input signal to the integration control unit 2600. The occupant and the like inputs various data and instructs a processing operation to the vehicle control system 2000 by operating the input unit 2800.

The storage unit 2690 may include a random access memory (RAM) for storing various programs executed by a microcomputer and a read only memory (ROM) for storing various parameters, calculation result, a sensor value, or the like. Also, the storage unit 2690 may be realized by a magnetic storage device such as a hard disc drive (HDD), a semiconductor storage device, an optical storage device, or a magneto-optical storage device.

The general-purpose communication I/F 2620 mediates communication with various devices existing in an external environment 2750. The general-purpose communication I/F 2620 may implement a cellular communication protocol such as the Global System of Mobile communications (GSM) (registered trademark), the WiMAX, the Long Term Evolution (LTE), or the LTE-Advanced (LTE-A) or other wireless communication protocol such as wireless LANs (Wi-Fi (registered trademark)). For example, the general-purpose communication I/F 2620 may he connected to a device (for example, application server or control server) existing on an external network (for example, internet, cloud network, or company-specific network) via a base station or an access point. Also, the general-purpose communication I/F 2620 may be connected to a terminal existing near the vehicle (for example, terminal of pedestrian or shop or machine type communication (MTC) terminal), for example, by using the peer to peer (P2P) technology.

The dedicated communication I/F 2630 supports a communication protocol established to be used for the vehicle. The dedicated communication I/F 2630 may, for example, implement a standard protocol such as the Wireless Access in Vehicle Environment (WAVE) which is a combination of the IEEE 802.11p of a lower layer and the IEEE 1609 of an upper layer or the Dedicated Short Range Communications (DSRC). The dedicated communication I/F 2630 typically performs V2X communication which is a concept including one or more of vehicle to vehicle communication, vehicle to infrastructure communication, and vehicle to pedestrian communication.

For example, the positioning unit 2640 receives a GNSS signal (for example, GPS signal from global positioning system (GPS) satellite) from a global navigation satellite system (GNSS) satellite and executes positioning. Then, the positioning unit 2640 generates position information including a latitude, a longitude, and a height of the vehicle. Furthermore, the positioning unit 2640 may specify the current position by exchanging a signal with a wireless access point and may obtain the position information from a terminal such as a mobile phone, a PHS, or a smartphone having a positioning function.

The beacon receiving unit 2650, for example, receives radio waves or electromagnetic waves transmitted from a wireless station installed on the road and obtains information including the current position, traffic congestion, a closed area, a required time, or the like. Also, the function of the beacon receiving unit 2650 may be included in the dedicated communication I/F 2630 described above.

The in-vehicle device I/F 2660 is a communication interface for mediating the connection between the microcomputer 2610 and various devices in the vehicle. The in-vehicle device I/F 2660 may establish wireless connection by using a wireless communication protocol such as a wireless LAN, the Bluetooth (registered trademark), Near Field Communication (NFC), or a wireless USB (WUSB). Also, the in-vehicle device I/F 2660 may establish wired connection via a connection terminal (and cable if necessary) which is not shown. The in-vehicle device I/F 2660, for example, exchanges a control signal or a data signal with a mobile device or a wearable device of the occupant or an information device carried in or attached to the vehicle.

The in-vehicle network I/F 2680 is an interface for mediating the communication between the microcomputer 2610 and the communication network 2010. The in-vehicle network I/F 2680 transmits and receives a signal and the like in accordance with a predetermined protocol supported by the communication network 2010.

The microcomputer 2610 of the integration control unit 2600 controls the vehicle control system 2000 according to various programs on the basis of information obtained at least one of the general-purpose communication I/F 2620 the dedicated communication I/F 2630, the positioning unit 2640, the beacon receiving unit 2650, the in-vehicle device I/F 2660, and the in-vehicle network I/F 2680. For example, the microcomputer 2610 may calculate a control target value of a driving force generating device, a steering mechanism, or a braking device on the basis of the obtained information inside and outside the vehicle and output a control instruction to the driving system control unit 2100. For example, the microcomputer 2610 may perform cooperative control to avoid or relax a collision of the vehicle, to perform a following travel based on an inter-vehicle distance, to perform speed keeping travel, to perform an automatic operation, and the like.

The microcomputer 2610 may create local map information including peripheral information of he current position of the vehicle on the basis of the information obtained via at least one of the general-purpose communication I/F 2620, the dedicated communication I/F 2630, the positioning unit 2640, the beacon receiving unit 2650, the in-vehicle device I/F 2660, and the in-vehicle network I/F 2680. Also, the microcomputer 2610 may predict a danger such as a collision of the vehicle, approach of a pedestrian, or entry to the closed road on the basis of the obtained information and generate a warning signal. The warning signal may be, for example, a signal to generate warning sound or to light a warning lamp.

The sound and image output unit 2670 transmits an output signal which is one of a voice or an image to an output device which can visually or auditorily notify information of the occupant of the vehicle or the outside the vehicle. In the example in FIG. 17, an audio speaker 2710, a display unit 2720, and an instrument panel 2730 are exemplified as the output device. The display unit 2720 may include, for example, at least one of an on-board display and a head-up display. The display unit 2720 may have an augmented reality (AR) display function. The output device may be a device such as a headphone, a projector, or a lamp other than these devices. In a case where the output device is a display device, the display device visually displays the result obtained by various processing performed by the microcomputer 2610 or information received from the other control unit in various formats such as a text, an image, a chart, and a graph. Also, in a case where the output device is a sound output device, the sound output device converts an audio signal including reproduced audio data or acoustic data into an analog signal and auditorily outputs the signal.

Also, in the example illustrated in FIG. 17, at least two control units connected via the communication network 2010 may be integrated as a single control unit. Alternatively, each control unit may include a plurality of control units. In addition, the vehicle control system 2000 may include other control unit which is not shown. Also, in the above description, other control unit may have a part of or all of the function of any one of controls units. That is, if information can be transmitted and received via the communication network 2010, any one of the control units may perform predetermined operation processing. Similarly, a sensor or a device connected to any one of the control units may be connected to the other control unit, and the control units may transmit and receive detection information to/from each other via the communication network 2010.

In the vehicle control system 2000 described above, the imaging unit 201 in FIG. 7 can be applied to, for example, the imaging unit 2410 in FIG. 17. Also, the image processing unit 202 in FIG. 7 can be applied to, for example, the external information detecting unit 2400 in FIG. 17. Therefore, the depth of the image outside the vehicle having the repetitive pattern can be estimated with high accuracy. As a result, accuracy of a refocus image is improved.

Also, the effects described herein are only exemplary and not limited to these. Also, there may be an additional effect.

In addition, an embodiment of the present disclosure is not limited to the embodiments described above and can be variously changed without departing the scope of the present disclosure. For example, the peripheral cameras 221-1 to 221-N may be arranged in a polygonal shape other than a regular pentagon, a regular hexagon, a regular dodecagon around the reference camera 221-0.

Also, the present technology can be applied to a multi-baseline stereo camera.

Furthermore, the present disclosure can have a configuration below.

(1)

An image pickup device including:

a plurality of imaging units configured to be arranged according to a base line length based on a reciprocal of a different prime number while a position of an imaging unit, to be a reference when images from different viewpoints are imaged, is used as a reference.

(2)

The image pickup device according to (1), in which the base line length is a value obtained by multiplying reciprocals of different prime numbers by a predetermined value.

(3)

The image pickup device according to (1) or (2), in which

the base line length is a horizontal base line length which is a base line length in a horizontal direction or a vertical base line length which is a base line length in a vertical direction.

(4)

The image pickup device according to (1) or (2), in which

the base line length includes a horizontal base line length which is a base line length in a horizontal direction and a vertical base line length which is a base line length in a vertical direction.

(5)

The image pickup device according to any one of (1) to (4), in which

the plurality of imaging units and the imaging unit to be a reference are arranged in a cross shape.

(6)

The image pickup device according to any one of (1) to (4), in which

the number of the imaging units is equal to or more than four, and

a part of a shape formed by connecting three or more adjacent imaging units is the same.

(7)

The image pickup device according to (6), in which

the plurality of imaging units is arranged in a polygonal shape around the imaging unit to be the reference.

(8)

The image pickup device according to (6), in which the plurality of imaging units is arranged in a pentagonal shape around the imaging unit to be the reference.

(9)

The image pickup device according to (6), in which

the plurality of imaging units is arranged in a hexagonal shape and a dodecagonal shape around the imaging unit to be the reference.

(10)

The image pickup device according to (9), in which

sides of the hexagonal shape and the dodecagonal shape are equal to each other.

(11)

The image pickup device according to any one of (1) to (10), in which

the plurality of imaging units and the imaging unit to be the reference obtain images according to the same synchronization signal.

(12)

The image pickup device according to (11), further including:

a storage unit configured to store the images obtained by the plurality of imaging units and the imaging unit to be the reference;

a read controlling unit configured to control reading of the images stored in the storage unit; and

a correction unit configured to correct the image read by control of the read controlling unit.

(13)

The image pickup device according to (12), further including:

a depth estimating unit configured to estimate a depth of the image obtained by the imaging unit to be the reference by using the image corrected by the correction unit and generate a parallax image of the image; and

a generation unit configured to generate a super multi-viewpoint image by using the parallax image of the imaging unit to be the reference generated by the depth estimating unit and the images obtained by the plurality of imaging units and the imaging unit to be the reference.

(14)

An image pickup method including

a step of imaging images from different viewpoints by a plurality of imaging units and an imaging unit to be a reference arranged according to a base line length based on reciprocals of different prime numbers as having a position of the imaging unit, to be the reference when images from different viewpoints are imaged, as a reference.

### REFERENCE SIGNS LIST

200 light field camera

230 reference camera

231 to 234 peripheral camera

250 reference camera

251 to 258 peripheral camera

270 reference camera

271 to 278 peripheral camera

290 reference camera

291 to 295 peripheral camera

310 reference camera

311 to 328 peripheral camera

1. An image pickup device including
a plurality of imaging units configured to be arranged according to a base line length based on a reciprocal of a different prime number while a position of an imagine unit, to be a reference when images from different viewpoints are imaged, is used as a reference.

2. The image pickup device according to claim 1, wherein
the base line length is a value obtained by multiplying reciprocals of different prime numbers by a predetermined value.

3. The image pickup device according to claim 2, wherein
the base line length is a horizontal base line length which is a base line length in a horizontal direction or a vertical base line length which is a base line length in a vertical direction.

4. The image pickup device according to claim 2, wherein
the base line length includes a horizontal base line length which is a base line length in a horizontal direction and a vertical base line length which is a base line length in a vertical direction.

5. The image pickup device according to claim 1, wherein
the plurality of imaging units and the imaging unit to be a reference are arranged in a cross shape.

6. The image pickup device according to claim 1, wherein
the number of the imaging units is equal to or more than four, and
a part of a shape formed by connecting three or more adjacent imaging units is the same.

7. The image pickup device according to claim 6, wherein
the plurality of imaging units is arranged in a polygonal shape around the imaging unit to be the reference.

8. The image pickup device according to claim 6, wherein
the plurality of imaging units is arranged in a pentagonal shape around the imaging unit to be the reference.

9. The image pickup device according to claim 6, wherein
the plurality of imaging units is arranged in a hexagonal shape and a dodecagonal shape around the imaging unit to be the reference.

10. The image pickup device according to claim 9, wherein
sides of the hexagonal shape and the dodecagonal shape are equal to each ocher.

11. The image pickup device according to claim 1, wherein
the plurality of imaging units and the imaging unit to be the reference obtain images according to the same synchronization signal.

12. The image pickup device according to claim 11, further comprising:
a storage unit configured to store the images obtained by the plurality of imaging units and the imaging unit to be the reference;
a read controlling unit configured to control reading of the images stored in the storage unit; and
a correction unit configured to correct the image read by control of the read controlling unit.

13. The image pickup device according to 12, further comprising:
a depth estimating unit configured to estimate a depth of the image obtained by the imaging unit to be the reference b by using the image corrected by the correction unit and generate a parallax image of the image; and
a generation unit configured to generate a super multi viewpoint image by using the parallax image of the imaging unit to be the reference generated by the depth estimating unit and the images obtained by the plurality of imaging units and the imaging unit to be the reference.

14. An image pickup method including:
a step of imaging images from different viewpoints by a plurality of imaging units and an imaging unit to be a reference arranged according to a base line length based on reciprocals of different prime numbers as having a position of the imaging unit, to be the reference when images from different viewpoints are imaged, as a reference.
